(19) United States
(12) Patent Application Publication
(10) Pub. No.: US 2012/0226750 A1
(43) Pub. Date: Sep. 6, 2012

(54) ONLINE PEER REVIEW OF INTERNET DATA

(76) Inventor: Rex Gibson, Bend, OR (US)

(21) Appl. No.: 13/402,487

(22) Filed: Feb. 22, 2012

Related U.S. Application Data
(60) Provisional application No. 61/448,115, filed on Mar. 1, 2011.

(51) Int. Cl. G06F 15/16

(52) U.S. Cl. 709/204

(57) ABSTRACT

A process is provided to enable users of online search engine services to get information enabling those users to discriminate between sites produced by those search engines as a result of a search inquiry, so that the user will have the benefit of trusted peer review before selecting which link or links to visit. The process includes the steps of: receiving an application by a user to be a validator; reviewing the received application; approving the user as a validator; providing an interface for the validator to review a result of a first query in the validator's field of expertise; receiving, from the validator, an indication of an accuracy and an indication of a neutrality of the result of the first query; and presenting the indication of the quality of the result, in response to a second query.

### CLAIM FOR PRIORITY AND CROSS-REFERENCE TO RELATED APPLICATIONS

This application claims the priority of Provisional Patent Application Ser. No. 61/448,115, filed on Mar. 1, 2011.

### FIELD OF THE INVENTION

The present invention relates to a device and process for providing online peer review of online data, and particularly for online search engine results.

### BACKGROUND OF THE INVENTION

Online search engines produce results of many kinds. Examples of such results are links to useful sites with valuable information, services, or goods; academic and governmental web sites of varying degrees of usefulness; less useful sites with less good information or even inaccurate information; spam sites; scam sites which use fraudulent or unethical means for financial benefit to the owners of those sites; and/or sites which contain mainly advertising, to harmful sites. This listing is exemplary, and other types of sites and search results also exist and can be subject to such peer review.

It is a problem in art to enable users of search engine services to get convenient, useful information enabling those users to discriminate between sites, so that the user would have the benefit of trusted peer review before selecting which link or links to visit.

It is a further problem in art to enable users of online services to get convenient, useful information about specific links or sites enabling those users to discriminate between those links and sites, so that the user would have the benefit of trusted peer review before selecting which link to choose and/or which sites to visit.

### SUMMARY OF THE INVENTION

From the foregoing, it is seen that it is a problem in the art to provide a device and process meeting the above requirements. According to the present invention, a device and process are provided which meets the aforementioned requirements and needs in the prior art.

Specifically, the device according to the present invention provides a device and process for online peer review of internet data.

Online search engines produce results of many kinds. Examples of such results are links to useful sites with valuable information, services, or goods; academic and governmental web sites of varying degrees of usefulness; less useful sites with less good information or even inaccurate information; spam sites; scam sites which use fraudulent or unethical means for financial benefit to the owners of those sites; and/or sites which contain mainly advertising, to harmful sites. This listing is exemplary, and other types of sites and search results also exist and can be subject to such peer review.

The device and process of the present invention enables users of online search engine services to get convenient, useful information enabling those users to discriminate between sites produced by those search engines as a result of a search inquiry, so that the user will have the benefit of trusted peer review before selecting which link or links to visit.

Broadly, embodiments of the present invention generally provide a method of providing an information quality rating on the internet in the form of subject-specific peer review. The method of the present invention includes the steps of: receiving an application by a user to be a validator; reviewing the received application; approving the user as a validator; providing an interface for the validator to review a result of a first query in the validator's field of expertise; receiving, from the validator, an indication of an accuracy and an indication of a neutrality of the result of the first query; and presenting the indication of the quality of the result, in response to a second query.

The foregoing sequence may be repeated on further results and queries.

Aspects of the present invention provide a method of combining knowledgeable persons who are chosen to evaluate search engine results to produce search engine results that have been qualified by a subject matter expert.

Aspects of the present invention include a peer review of online links or websites, and the information contained therein.

In an embodiment of the present invention, a method of providing an information quality rating may include a step of providing an interface for receiving an application by a user who desires to be a validator. The application may include questions relating to establishing the user as a subject matter expert or suitably knowledgeable in a particular field or area. The method may include a step of reviewing the application received from the user, which may include reviewing and evaluating the qualifications of the user to determine whether the user meets minimum requirements to qualify as a validator. The method may include a step of approving or denying the user as a validator. The method may include a step of providing an interface for the validator to submit a query that may yield a result or list of results whether it be a stand alone search engine or an added feature to an existing search engine.

The method may include receiving a review, from the validator, of the result or list of results. The validator may review the result or list of results using a plurality of criteria including, for example but not limited to, accuracy and neutrality (e.g., bias) of the content of the result or list of results. In response to reviewing the result or list of results, the validator may determine a quality of the plurality of criteria by submitting a grade or rating, which may include, for example, a numeric value, a letter, a scale score, or a qualitative evaluation.

In an exemplary embodiment, the letter used to evaluate, for example, the accuracy of the result or list of results may include A-F inclusive. In another exemplary embodiment, the qualitative evaluation used to evaluate the neutrality of the result or list of results may include “Yes,” “Somewhat,” and “No.”

The method may include a step of receiving a category of the result or list of results, which may be determined by the validator. The categories that may be selected by the validator may include but not limited to, for example, Information, Business, Social, Leisure, Mature, and Miscellaneous. The method may include a qualification or evaluation of the result or list of results relating to e-commerce quality, digital safety and validity, which may include verification of certificate authorities, detection of malware, detection of malicious code, and detection of attacks including, for example, confidentiality, availability, and integrity impact attacks. The method may include a step of compiling or collecting evaluations provided by a validator. In an exemplary embodiment, a plurality of collected evaluations may be, for example, averaged or weighted for a result or list of results to create an aggregate evaluation therefor.

The method may include presenting the indication of the quality of the result, in response to a second query that may produce and include the result or list of results. The indication of the quality of the result may include, for example, a gauge configured to resemble a traffic light having red, yellow, and green indicators, and a gauge configured to resemble an analog dial having a needle.

In another embodiment, the indication of the quality of the result may include the selected category of the result.

According to some embodiments, certain aspects of the present invention may be performed by a human or by an automated computer system configured to evaluate certain criteria or use artificial intelligence to make determinations or evaluations. According to other embodiments, certain aspects of the present invention may be configured as an add-on, an extension, or a gadget.

Other objects and advantages of the present invention will be more readily apparent from the following detailed description when read in conjunction with the accompanying drawings.

### BRIEF DESCRIPTION OF THE DRAWINGS

FIG. 1 is a flowchart schematically indicating steps for implementing the method of the present invention, namely a process for online peer review of internet data.

FIG. 2 is a schematic illustration depicting results of a search engine query together with visual indications of peer reviews associated with each individual result.

### DETAILED DESCRIPTION OF THE INVENTION

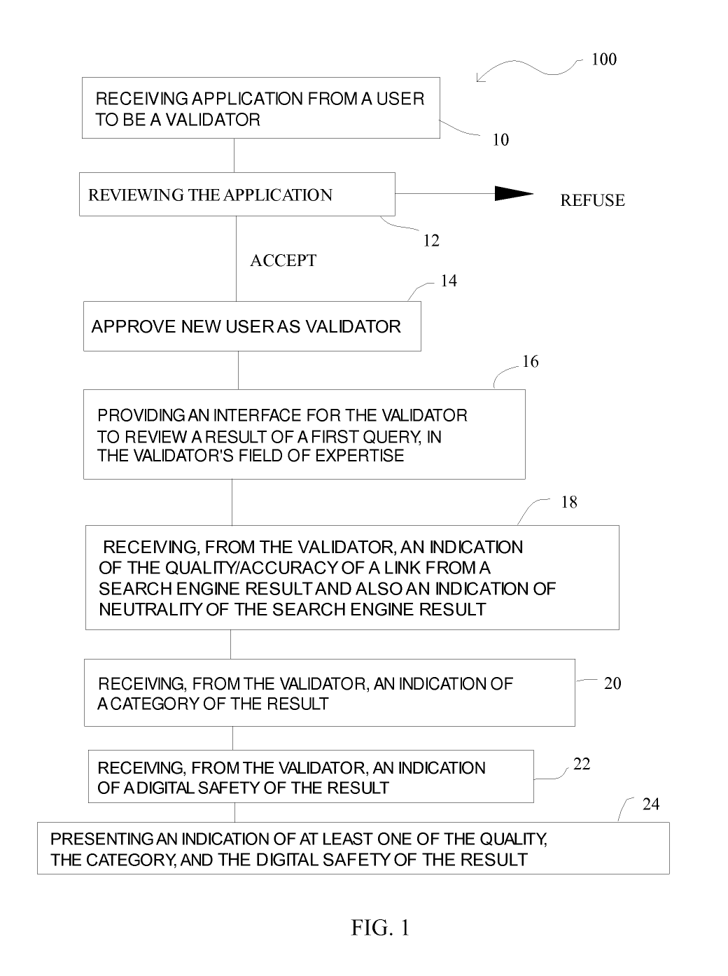

FIG. 1 is a flow chart schematically indicating a process 100 for online peer review of internet data. The internet data can be a listing of links produced as a result of search engine queries.

In the device and process of the present invention, it will be understood that computers and servers, and other computing means by various names including smartphones, touchpads, and other devices, are used at various stages, and such are referred to in the following as computing means. Further, it will be understood that communication between the computers and other devices comprising the computing means can occur via various forms of communication, and especially the form referred to as the Internet, and can also include cell phone communications, wireless communications, cable and satellite transmissions. When referring to search engines and search engine queries, these can include well known search engines which are well known and need no further description.

Online search engines produce results of many kinds. Examples of such results are links to useful sites with valuable information, services, or goods; academic and governmental web sites of varying degrees of usefulness; less useful sites with less good information or even inaccurate information; spam sites; scam sites which use fraudulent or unethical means for financial benefit to the owners of those sites; and/or sites which contain mainly advertising, to harmful sites. This listing is exemplary, and other types of sites and search results also exist and can be subject to such peer review.

The device and process 100 enables users of online search engine services to get convenient, useful information enabling those users to discriminate between sites produced by those search engines as a result of a search inquiry, so that the user will have the benefit of trusted peer review before selecting which link or links to visit.

The process 100 shown in FIG. 1 shows the following steps, to provide a method of providing an information quality rating on the internet in the form of subject-specific peer review. The method as shown in FIG. 1 includes: a step 10 of receiving an application by a user to be a validator; a step 12 of reviewing the received application, which can result in acceptance or refusal of the application; upon acceptance in step 12 there follows a step 14 of approving the user as a validator; a step 16 of providing an interface for the validator to review a result of a first query in the validator's field of expertise; and a step 18 of receiving, from the validator, an indication of an accuracy and an indication of a neutrality of the result of the first query.

The process 100 also includes the step 20 of receiving, from the validator, an indication of a category of the result; a step 22 of receiving, from the validator, an indication of a digital safety of the result; and a step 24 of presenting an indication of at least one of the quality, the category, and the digital safety of the result, in response to a second query.

In the aforementioned process 100, the process is repeated for individual validators, such that there will by a plurality of such validators. The aforementioned second query occurs, for example, when future users of a search engine service submit a query which produces results which have been reviewed by one of the plurality of validators.

The foregoing sequence may be repeated on further results and queries.

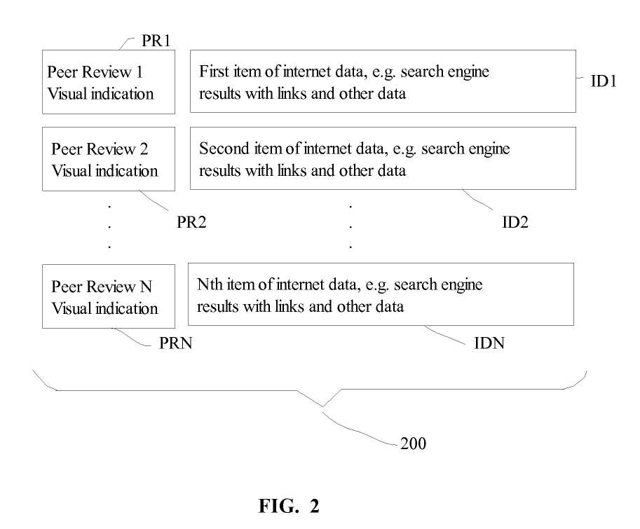

FIG. 2 is a schematic illustration depicting results 200 of a search engine query having individual listings of internet data (i.e. links, text, etc., resulting from a search engine query) ID1, ID2, . . . , IDN; together with visual indications of peer reviews associated with each individual result, namely PR1, PR2, . . . , PRN.

In the above-described embodiment of the present invention, a method of providing an information quality rating may include a step of providing an interface for receiving an application by a user who desires to be a validator. The application may include questions relating to establishing the user as a subject matter expert or suitably knowledgeable in a particular field or area. The method may include a step of reviewing the application received from the user, which may include reviewing and evaluating the qualifications of the user to determine whether the user meets minimum requirements to qualify as a validator. The method may include a step of approving or denying the user as a validator. The method may include a step of providing an interface for the validator to submit a query that may yield a result or list of results whether it be a stand alone search engine or an added feature to an existing search engine.

The method may include receiving a review, from the validator, of the result or list of results. The validator may review the result or list of results using a plurality of criteria including, for example but not limited to, accuracy and neutrality (e.g., bias) of the content of the result or list of results. In response to reviewing the result or list of results, the validator may determine a quality of the plurality of criteria by submitting a grade or rating, which may include, for example, a numeric value, a letter, a scale score, or a qualitative evaluation.

In an exemplary embodiment, the letter used to evaluate, for example, the accuracy of the result or list of results may include A-F inclusive. In another exemplary embodiment, the qualitative evaluation used to evaluate the neutrality of the result or list of results may include “Yes,” “Somewhat,” and “No.”

In the step 20 of receiving a category of the result or list of results, this category may be determined by the validator. The categories that may be selected by the validator may include but not limited to, for example, Information, Business, Social, Leisure, Mature, and miscellaneous. The method may include the aforementioned steps including a qualification or evaluation of the result or list of results relating to e-commerce quality, digital safety and validity, which may include verification of certificate authorities, detection of malware, detection of malicious code, and detection of attacks including, for example, confidentiality, availability, and integrity impact attacks. The method may include a step of compiling or collecting evaluations provided by a validator. In an exemplary embodiment, a plurality of collected evaluations may be, for example, averaged or weighted for a result or list of results to create an aggregate evaluation therefor.

The method may include presenting the indication of the quality of the result, in response to a second query that may produce and include the result or list of results. The indication of the quality of the result preferably includes, for example, one of a gauge configured to resemble a traffic light having red, yellow, and green indicators, and a gauge configured to resemble an analog dial having a needle, wherein the needle can point to regions shown in color as red, yellow, and green.

In another embodiment, the step of the indication of the quality of the result may include the selected category of the result.

According to these embodiments, certain aspects of the present invention may be performed by a human or by an automated computer system configured to evaluate certain criteria or use artificial intelligence to make determinations or evaluations. According to other embodiments, certain aspects of the present invention may be configured as an add-on, an extension, or a gadget.

The invention being thus described, it will be evident that the same may be varied in many ways. Such variations are not to be regarded as a departure from the spirit and scope of the invention and all such modifications are intended to be included within the scope of the claims.

What is claimed is:

1. A method of providing an information quality rating for a data listing, the method including computing means, comprising the steps of:
a step of receiving, from a user, an application to be a validator;
a step of reviewing the application, in response to said step of receiving;
a step of approving or refusing the user as a validator;
upon acceptance of the step of approving the user as a validator, a step of providing an interface for the validator to review a result of a first query in the validator's field of expertise;
a step of receiving, from the validator, an indication of an quality/accuracy and an indication of a neutrality of the result;
a step of receiving, from the validator, an indication of a category of the result;
a step of receiving, from the validator, an indication of a digital safety of the result; and
a step of presenting an indication of at least one of the quality, the category, and the digital safety of the result.

2. The method as claimed in claim 1, further comprising: repeating the steps on further results and queries.
